(19) United States
(12) Patent Application Publication
(10) Pub. No.: US 2026/0131756 A1
(43) Pub. Date: May 14, 2026

(54) TENSIONING DEVICE FOR A SAFETY BELT COMPONENT

(71) Applicant: AUTOLIV DEVELOPMENT AB, Vargarda (SE)

(72) Inventor: Ole Scharnberg, Hamburg (DE)

(21) Appl. No.: 19/390,060

(22) Filed: Nov. 14, 2025

(30) Foreign Application Priority Data
Nov. 14, 2024 (DE) 102024133346.4

(51) Int. Cl. B60R 22/195

(52) U.S. Cl. CPC B60R 22/1955; B60R 22/1952

(57) ABSTRACT

A tensioning device for a safety belt component, comprising a gas generator for generating a pressurized gas, a piston which can be driven by the pressurized gas, a traction cable which is connected to the piston and can be connected to a safety belt component to be set in a tensioning movement, a tensioner tube for receiving and guiding the piston, a gas generator housing accommodating the gas generator, wherein the gas generator housing is arranged in the tensioner tube, and a seal, wherein the seal seals the gas generator housing against an inner side of the tensioner tube on a side facing the piston, wherein the seal has a first sealing lip which extends along the longitudinal extension direction of the tensioner tube.

### CROSS-REFERENCE TO RELATED APPLICATION

This application claims priority pursuant to 35 U.S.C. 119(a) to German Application No. 102024133346.4, filed Nov. 14, 2024, which application is incorporated herein by reference in its entirety.

### FIELD OF THE INVENTION

The present invention relates to a tensioning device for a safety belt component. In particular, the present invention relates to a tensioning device comprising a gas generator, a piston, a traction cable, a tensioner tube, a gas generator housing and a special seal.

### BACKGROUND

In the field of vehicle safety, it is common practice to use various devices and mechanisms to increase the safety of vehicle occupants in the event of an accident. One of these devices is the safety belt, which is designed to keep passengers safely in their seats and thus minimize the risk of injury in the event of a collision. To further increase the effectiveness of safety belts, tensioning devices are often used to tighten the belt in the event of an accident, thus fastening the occupants even more securely. Known systems typically include a gas generator that is activated during an accident and produces a pressurized gas that drives a piston. This piston is connected to a traction cable, which in turn is connected to the safety belt component to trigger the tensioning movement.

According to known technology, these tensioning devices are often equipped with a tensioner tube that accommodates and guides the piston. The gas generator is housed in a gas generator housing which is located inside the tensioner tube. A seal ensures that the pressurized gas does not escape and drives the piston. Despite considerable progress in the field of tensioning devices, challenges remain, particularly regarding sealing and the efficiency of force transmission from the gas generator to the piston. Known sealing solutions may fail or not seal optimally under extreme conditions, which may impair the performance of the tensioning device.

Another problem is that the seals in existing systems are often not flexible enough to adapt to different pressure conditions and mechanical loads. This can lead to uneven contact pressure. In addition, inadequate seals can cause the pressurized gas to escape before it can fully drive the piston, which reduces the tensioning effect of the safety belt.

According to the prior art, O-rings are generally used as seals between the gas generator housing and the inside of the tensioner tube. A tensioning device having the features of the preamble of claim 1 is known from DE 10 2022 122 768 B3.

There is therefore a need for improved seals that provide more reliable sealing while being flexible enough to adapt to different operating conditions.

### SUMMARY

It is therefore an object of the present invention to provide a tensioning device which overcomes one or more of the disadvantages of the known tensioning devices and to provide a tensioning device with which a uniform tensioning process can be achieved more reliably.

The present invention relates to a tensioning device for a safety belt component, comprising a gas generator for generating a pressurized gas, a piston which can be driven by the pressurized gas, a traction cable which is connected to the piston and can be connected to a safety belt component to be set in a tensioning movement, a tensioner tube for receiving and guiding the piston, a gas generator housing accommodating the gas generator, wherein the gas generator housing is arranged in the tensioner tube, and a seal, wherein the seal seals the gas generator housing against an inner side of the tensioner tube on a side facing the piston, wherein the seal has a first sealing lip which extends along the longitudinal extension direction of the tensioner tube and, at least when the gas generator is triggered, lies flat against the inner side of the tensioner tube and is pressed against the inside of the tensioner tube by the pressurized gas.

The above-mentioned object is achieved by a tensioning device having the features of the independent claim. Advantageous developments are given in the dependent claims and in the preceding and following description, it being possible for individual features of the advantageous developments to be combined with one another in a technically expedient manner.

The object is achieved by means of a tensioning device which is provided for a safety belt component, and which can have a gas generator for generating a pressurized gas. A piston is driven by the pressurized gas and is connected to a traction cable, which in turn can be connected to a safety belt component to cause it to perform a tensioning movement. A tensioner tube serves to accommodate and guide the piston, while a gas generator housing accommodates the gas generator and is arranged in the tensioner tube. A seal is located on the side of the gas generator housing facing the piston, and seals it against the inside of the tensioner tube. The seal thus seals off the space inside the tensioner tube into which the pressurized gas is introduced and is intended to prevent the pressurized gas from escaping along the intermediate space between the outside of the gas generator housing and the inside of the tensioner tube.

The seal has a first sealing lip which extends along the longitudinal extension direction of the tensioner tube. This sealing lip lies flat against the inside of the tensioner tube, at least when the gas generator is triggered, and is pressed against the inside of the tensioner tube by the pressurized gas. An advantage of this design is a reliable and consistent tensioning process.

In other words: The basic concept of the present invention provides that the seal has a flat/level portion which is pressed against the inside of the tensioner tube at least in the event of triggering, so that a flat contact region is provided between the seal and the inside of the tensioner tube, in which the seal rests against the inside of the tensioner tube with uniform pressure. This flat/level portion of the seal is called the sealing lip. Compared to an O-ring with a circular cross-section, this provides a larger sealing surface, which also fits more uniformly on the inside of the tensioner tube. Since therefore less or no pressurized gas can escape along the gas generator housing, a more uniform tensioning process is ensured. The sealing lip can extend completely in the peripheral direction. However, it can also be provided that the sealing lip is formed in only one or more portions in the peripheral direction. The sealing lip is designed in particular in those regions of the tensioner tube where the tensioner tube itself has no curvature.

According to one embodiment, the tensioning device comprises a seal having a base portion that bears against an axial end face of the gas generator housing. The axial end face of the gas generator housing is the surface of the housing that is oriented in the direction of the longitudinal axis of the tensioner tube and faces the piston. The end face of the gas generator housing can have a plurality of portions, arranged in steps relative to one another. The end face or the portions of the end face is/are preferably flat/level. The base portion of the seal is the part of the seal that lies directly against the axial end face or a portion of the axial end face of the gas generator housing. This region of the base portion is preferably flat or level, to enable optimal sealing. This flat contact provides improved sealing between the gas generator housing and the tensioner tube, which increases the efficiency of the tensioning device. The flat design of both the axial end face and the base portion helps to ensure that the pressurized gas generated by the gas generator cannot escape in an uncontrolled manner, and thus the full energy of the pressurized gas can be used to move the piston. The flat contact of the base portion on the axial end face ensures that the seal seals reliably even at high pressures and rapid piston movements, and that the energy of the pressurized gas is used effectively.

According to one embodiment, the tensioning device has a specific arrangement/configuration of the seal, in which the base portion of the seal rests against the end face of the gas generator housing at a distance from an outer edge of the end face of the gas generator housing. Thus, a radial (outer) edge of the base portion is spaced from a radial (outer) edge of the gas generator housing. The base portion therefore does not extend as far as the radial edge of the gas generator housing on the end face. This arrangement of the seal has several advantages. By spacing the base portion from the outer edge of the end face of the gas generator housing, the seal is prevented from being pressed into the minimal gap between the gas generator housing and the inside of the tensioner tube. This is advantageous in order to ensure reliable sealing and efficient transmission of the pressurized gas. The seal thus remains in its intended position and ensures that the pressurized gas can drive the piston optimally, without any leaks or loss of pressure.

According to one embodiment, the tensioning device has a seal which is conical on its outer periphery in the transition from the base portion to the first sealing lip. The diameter of the seal therefore increases from the base portion facing the end face of the gas generator housing to the first sealing lip. This conical design of the seal in the transition region ensures effective sealing and prevents the seal from being pressed into the minimal gap between the gas generator housing and the inside of the tensioner tube. This special shaping provides additional stability to the seal, allowing it to optimally absorb and distribute the pressure of the generated gas. The conical shape allows the seal to adhere uniformly to the inner wall of the tensioner tube when pressure is applied, which increases the sealing effect and improves the reliability of the tensioning device without being pressed into the gap. By preventing the seal from penetrating the gap, the risk of malfunctions is also minimized, resulting in greater operational reliability of the entire device.

According to one embodiment of the tensioning device, the first sealing lip extends in the axial direction beyond the gas generator housing. This specific extension of the sealing lip enables improved sealing and interaction between the components of the tensioning device. The sealing lip, which extends along the longitudinal extension direction of the tensioner tube, ensures that the gas generator housing is effectively sealed against the inside of the tensioner tube. Due to the axial extension of the sealing lip beyond the gas generator housing, the sealing effect is maintained even in the case of movement of the piston and resulting pressurized gas development. This leads to improved efficiency of the tensioning device, as the pressurized gas is used optimally to drive the piston and thus cause the safety belt component to perform a tensioning movement. The extended sealing lip ensures that the pressurized gas cannot escape and thus the full energy of the gas generator is available. The first sealing lip extends at least 5 mm, preferably at least 10 mm, beyond the gas generator housing along the inside of the tensioner tube.

According to one embodiment, the tensioning device has a second sealing lip which extends along the longitudinal extension direction of the tensioner tube and, at least in the event of triggering of the gas generator, lies flat against a radially outwardly directed surface of the gas generator housing and is pressed by the pressurized gas against the radially outwardly directed surface of the gas generator housing. This radially outwardly directed surface of the gas generator housing is arranged between two portions of the axial end face of the gas generator housing, whereby the end face of the gas generator housing is designed in a step-like manner. Due to this arrangement/design, the second sealing lip lies flat against the outwardly directed surface of the gas generator housing, which further increases the tightness between the gas generator housing and the tensioner tube. The second sealing lip thus acts as an additional barrier against the escape of the pressurized gas and ensures that the pressurized gas is used efficiently to drive the piston and initiate the tensioning movement of the safety belt component. This leads to further improved performance of the tensioning device, as no unwanted leaks occur. The stepped design of the end face of the gas generator housing supports effective sealing by providing a suitable support surface for the second sealing lip. This additional sealing lip thus contributes to the overall reliability and efficiency of the tensioning device by ensuring double sealing in combination with the first sealing lip and minimizing the risk of pressure losses. The second sealing lip ensures that when the gas generator is activated, the seal is pressed against the axial outwardly directed surface by the pressurized gas, creating a secure and tight connection.

The first sealing lip and the second sealing lip are formed integrally in one piece with the base portion. The first sealing lip extends from the base portion along the longitudinal extension of the tensioner tube in contact with the inside of the tensioner tube, while the second sealing lip extends from the base portion along the longitudinal extension direction of the tensioner tube in contact with the radially outwardly directed surface of the gas generator housing. The base portion thus connects the first sealing lip and the second sealing lip. In this case, on the side facing the pressure chamber, the seal is preferably U-shaped, it being possible for the leg of the U-shape forming the first sealing lip to be longer than the leg of the U-shape forming the second sealing lip, in which case the side is more J-shaped.

According to one embodiment, the tensioning device comprises a first sealing lip which extends in the longitudinal extension direction of the tensioner tube by at least 1.5 times, preferably by twice, the length of the second sealing lip. This specific design of the first sealing lip enables improved sealing and increases the efficiency of the tensioning device. The longer first sealing lip ensures that when the gas generator is triggered there is a larger contact surface between the sealing lip and the inside of the tensioner tube. This forces the pressurized gas more effectively against the inside of the tensioner tube, resulting in improved sealing. The extended first sealing lip also improves the adaptability of the seal to possible irregularities or tolerances in the inside of the tensioner tube, which further increases the overall reliability of the tensioning device.

According to one embodiment, the tensioning device has a first sealing lip which extends to different distances in the longitudinal extension direction at different points in the peripheral direction. The different extension of the sealing lip in the longitudinal direction achieves an improved adaptation to the inside of the tensioner tube, which increases the efficiency of the seal. In this way, the seal is adapted to the cross-sectional geometry of the tensioner tube. This results in better sealing against the pressurized gas and thus prevents the gas from escaping at unwanted locations. A further advantage of this embodiment is the increased flexibility of the seal, which can better adapt to the shape and possible irregularities of the inside of the tensioner tube. The specific design of the sealing lip can also facilitate the manufacture and assembly of the tensioning device, as it ensures a more precise fit.

According to one embodiment of the tensioning device for a safety belt component, the first sealing lip has a special configuration in which it extends further adjacently to the traction cable than at more distant locations. This specific design of the sealing lip optimizes sealing near the traction cable.

According to one embodiment, the seal comprises reinforcing ribs. These reinforcing ribs are structural elements that are integrated into/onto the first sealing lip and increase its mechanical strength and stability. The reinforcing ribs further stabilize the sealing lip, improving its ability to withstand the pressure of the generated gas and ensure effective sealing. The reinforcing ribs ensure that the sealing lip retains its shape and is not deformed even under high pressure conditions, which increases the reliability of the seal. The reinforcing ribs can be made of the same material as the sealing lip or of another, particularly resistant material that further improves the structural integrity of the sealing lip. By integrating these reinforcing ribs into the sealing lip, the entire tensioning device becomes more robust and reliable.

According to one embodiment, the tensioning device comprises two or an even number of reinforcing ribs arranged (in pairs) diametrically opposite one another on the seal. By arranging the reinforcing ribs on opposite sides of the seal, an even distribution of the forces acting on the seal is achieved. This prevents the seal from deforming or shifting, which could lead to a loss of sealing. The reinforcing ribs further stabilize the sealing lip and improve its functionality. The reinforcing ribs can be an integral component of the seal and manufactured in a single manufacturing step, reducing production costs and increasing manufacturing efficiency.

According to one embodiment, the tensioning device comprises two diametrically opposed reinforcing ribs which have more mass than the other reinforcing ribs. The additional mass of the two specific reinforcing ribs achieves an improved distribution of the forces acting on the seal, resulting in more effective sealing. The specific arrangement and mass distribution of the reinforcing ribs are designed such that they provide an optimal balance between flexibility and strength, allowing the seal to reliably perform its function even under extreme conditions.

According to one embodiment of the tensioning device, the reinforcing ribs extend as far as the second sealing lip provides additional structural support and stability for the seal. The reinforcing ribs ensure that the seal retains its shape and position even under high pressure and during rapid piston movements. The reinforcing ribs also help facilitate the assembly of the tensioning device by allowing precise positioning and alignment of the seal within the tensioner tube. This reduces the likelihood of assembly errors and improves the overall quality of the tensioning device.

According to one embodiment of the invention, the seal is formed in one piece. This one-piece design of the seal brings several advantages. First, the production of the seal is simplified because no additional assembly steps are required to connect a plurality of parts together. This leads to a reduction in production costs and an increase in the reliability of the seal, as potential weak points that could arise from connection points are eliminated. A one-piece seal also offers improved sealing performance because there are no joints or transitions through which pressurized gas could escape.

### BRIEF DESCRIPTION OF THE DRAWINGS

The invention and the technical environment are explained below by way of example with reference to the schematic figures.

FIG. 1 shows an embodiment of a tensioning device for a safety belt component;

FIG. 2 shows the embodiment of the tensioning device in cross-section;

FIG. 3 is a detailed cross-sectional view of the seal and the gas generator housing of the tensioning device;

FIG. 4 shows the seal in the tensioning device; and,

FIG. 5 is a perspective view of the seal.

### DETAILED DESCRIPTION OF THE INVENTION

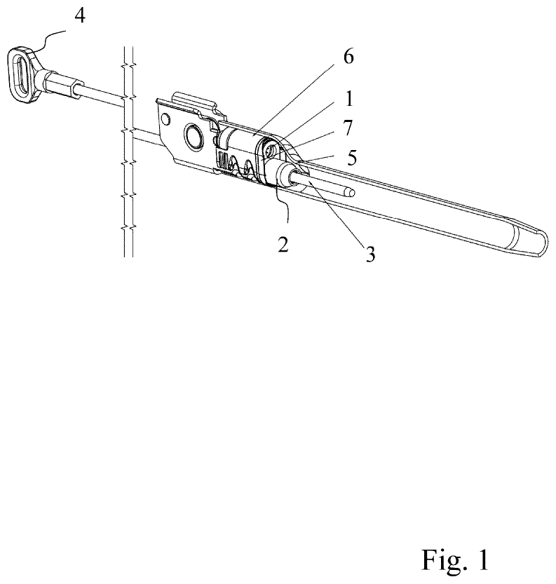

FIG. 1 shows a tensioning device for a safety belt component. The device comprises a gas generator 1 for generating a pressurized gas. The gas generator 1 is housed in a gas generator housing 6, which in turn is arranged in a tensioner tube 5.

A piston 2, which is driven by the pressurized gas, is also arranged in the tensioner tube 5. A traction cable 3 is connected to the piston 2, which cable is connected to a safety belt component 4 which is to be set into a tightening movement.

A seal 7, also shown in FIG. 5, is located on the side of the gas generator housing 6 facing the piston 2 and seals said housing against the inside of the tensioner tube 5. The seal 7 has a first sealing lip 7.1, which extends along the longitudinal extension direction of the tensioner tube 5 and, at least in the event of triggering of the gas generator 1, lies flat against the inside of the tensioner tube 5 and is pressed against the inside of the tensioner tube by the pressurized gas.

In addition, the seal 7, which is visible in more detail in FIGS. 3 to 5, has a base portion 7.3 which rests against an axial end face of the gas generator housing 6. The base portion 7.3 is spaced apart from an outer edge of the end face of the gas generator housing 6. In the transition from the base portion 7.3 to the first sealing lip 7.1, the seal 7 is conical on its outer periphery.

The seal 7 also has a second sealing lip 7.2, which extends along the longitudinal extension direction of the tensioner tube 5 and, at least in the event of triggering of the gas generator 1, lies flat against a radially outwardly directed surface 6.3 of the gas generator housing 6 and is pressed against this surface 6.3 by the pressurized gas.

The first sealing lip 7.1 is at least 1.5 times the length of the second sealing lip 7.2 in the longitudinal extension direction of the tensioner tube 5. At different points in the peripheral direction, the first sealing lip 7.1 extends to different distances in the longitudinal extension direction, wherein adjacent to the traction cable 3 it extends further than at points further away.

The first sealing lip 7.1 has reinforcing ribs 7.4, with two reinforcing ribs 7.4 being arranged diametrically opposite each other on the seal 7. The diametrically opposed reinforcing ribs 7.4 arranged at the top and bottom in the figures have more mass than the other reinforcing ribs 7.4.

The seal 7 is designed in one piece to ensure easy assembly and reliable sealing.

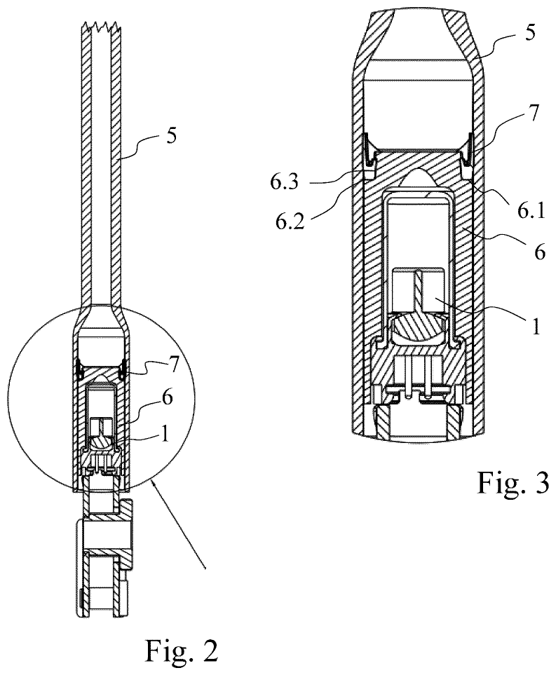

FIG. 2 and FIG. 3 show a detailed representation of the tensioning device for a safety belt component.

FIG. 2 is a sectional view of the tensioning device, showing the tensioner tube 5, the gas generator 1, the gas generator housing 6 and the seal 7. The tensioner tube 5 serves to accommodate and guide the piston 2, which is driven by the pressurized gas from the gas generator 1. The gas generator housing 6 is arranged within the tensioner tube 5 and accommodates the gas generator 1. The seal 7 is located on the side of the gas generator housing 6 facing the piston 2 and seals said housing against the inside of the tensioner tube 5.

FIG. 3 is an enlarged view of the lower region of the tensioning device, in which the seal 7 is shown in more detail. The first sealing lip 7.1 can be seen, which extends along the longitudinal extension direction of the tensioner tube 5 and, in the event of the gas generator 1 being triggered, lies flat against the inside of the tensioner tube 5. This first sealing lip 7.1 is pressed against the inside of the tensioner tube 5 by the pressurized gas to ensure effective sealing.

In addition, FIG. 3 shows that the seal 7 has a base portion 7.3 which rests against an axial end face 6.1 of the gas generator housing 6. The base portion 7.3 is arranged at a distance from an outer edge 6.2 of the end face 6.1 of the gas generator housing 6, which enables precise positioning of the seal 7 and improves the sealing.

Furthermore, FIG. 3 shows the second sealing lip 7.2, which also extends along the longitudinal extension direction of the tensioner tube 5. In the event of the gas generator 1 being triggered, this second sealing lip 7.2 lies flat against the radially outwardly directed surface 6.3 of the gas generator housing 6 and is pressed against this surface 6.3 by the pressurized gas.

The first sealing lip 7.1 extends in the axial direction beyond the gas generator housing 6 and has the reinforcing ribs 7.4, which increases the structural integrity of the seal 7.

The seal 7 is designed in one piece, which allows for easy manufacture and assembly.

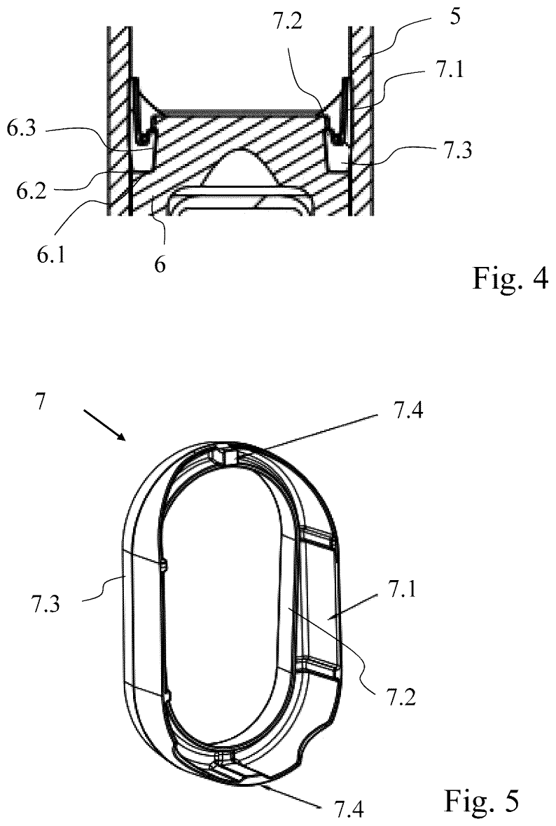

FIG. 4 shows the cross-section of the tensioning device, particularly the arrangement of the seal 7 within the tensioner tube 5. The gas generator housing 6 is positioned inside the tensioner tube 5.

FIG. 5 is a perspective view of the seal 7. This seal 7 is formed in one piece and comprises the first sealing lip 7.1, the second sealing lip 7.2 and the base portion 7.3. The seal 7 is conical on its outer periphery in the transition from the base portion 7.3 to the first sealing lip 7.1. In addition, the seal 7 has the reinforcing ribs 7.4, which serves to increase the structural integrity. Two of these reinforcing ribs 7.4 are arranged diametrically opposite each other on the seal 7. The reinforcing ribs 7.4 extend as far as the second sealing lip 7.2.

The specific design of the sealing lips 7.1, 7.2 and reinforcing ribs 7.4 contributes to the effective sealing and functionality of the tensioning device by ensuring that the pressurized gas is optimally used to quickly and reliably tension the safety belt component in the event of an accident.

### LIST OF REFERENCE SIGNS

1 Gas generator
2 Piston
3 Traction cable
4 Safety belt component
5 Tensioner tube
6 Gas generator housing
6.1 Axial end face
6.2 Outer edge
6.3 Radially outwardly directed surface
7 Seal
7.1 First sealing lip
7.2 Second sealing lip
7.3 Base portion
7.4 Reinforcing rib

What is claimed is:

1. A tensioning device for a safety belt component, comprising
a gas generator for generating a pressurized gas,
a piston that can be driven by the pressurized gas,
a traction cable which is connected to the piston and can be connected to a safety belt component that is to be set into a tensioning movement,
a tensioner tube for receiving and guiding the piston,
a gas generator housing accommodating the gas generator, wherein the gas generator housing is arranged in the tensioner tube, and,
a seal, wherein the seal seals the gas generator housing against an inner side of the tensioner tube on a side facing the piston, wherein the seal has a first sealing lip which extends along the longitudinal extension direction of the tensioner tube and, at least when the gas generator is triggered, lies flat against the inside of the tensioner tube and is pressed against the inside of the tensioner tube by the pressurized gas.

2. A tensioning device according to claim 1, wherein the seal has a base portion which bears against an axial end face of the gas generator housing.

3. A tensioning device according to claim 2, wherein the base portion abuts against the axial end face of the gas generator housing at a distance from an outer edge of the axial end face.

4. A tensioning device according to claim 3, wherein the seal is conical on its outer periphery in the transition from the base portion to the first sealing lip.

5. A tensioning device according to claim 1, wherein the first sealing lip extends in the axial direction beyond the gas generator housing.

6. A tensioning device according to claim 1, wherein the seal has a second sealing lip which extends along the longitudinal extension direction of the tensioner tube and, at least in the event of triggering of the gas generator, lies flat against a radially outwardly directed surface of the gas generator housing and is pressed by the pressurized gas against the radially outwardly directed surface of the gas generator housing.

7. A tensioning device according to claim 6, wherein the first sealing lip is at least 1.5 times, preferably at least twice the length of the second sealing lip in the longitudinal extension direction of the tensioner tube.

8. A tensioning device according to claim 1, wherein the first sealing lip extends to different distances in the longitudinal extension direction at different locations in the peripheral direction.

9. A tensioning device according to claim 8, wherein adjacent to the traction cable the first sealing lip extends further than at more distant locations.

10. A tensioning device according to claim 1, wherein the first sealing lip has reinforcing ribs.

11. A tensioning device according to claim 10, wherein two reinforcing ribs are arranged diametrically opposite each other on the seal.

12. A tensioning device according to claim 10, wherein two diametrically opposed reinforcing ribs have more mass than the remaining reinforcing ribs.

13. A tensioning device according to claim 10, wherein the reinforcing ribs extend as far as the second sealing lip.

14. A tensioning device according to claim 1, wherein the seal is formed in one piece.
